(19) United States
(12) Patent Application Publication
(10) Pub. No.: US 2026/0042172 A1
(43) Pub. Date: Feb. 12, 2026

(54) MANUFACTURING METHOD AND MANUFACTURING APPARATUS OF WELDED MEMBER

(71) Applicant: FUTABA INDUSTRIAL CO., LTD., Okazaki-shi (JP)

(72) Inventor: Shota Muto, Okazaki-shi (JP)

(21) Appl. No.: 19/278,439

(22) Filed: Jul. 23, 2025

(30) Foreign Application Priority Data
Aug. 9, 2024 (JP) 2024-134453

(51) Int. Cl. B23K 26/70; B23K 26/21

(52) U.S. Cl. CPC B23K 26/703; B23K 26/21

(57) ABSTRACT

A manufacturing method of a welded member includes irradiating a joining portion of two metal members with a laser beam and moving an irradiation region of the laser beam along the joining portion and supplying a cooling material to a molten pool to be generated in the joining portion by irradiation of the laser beam, thereby cooling the molten pool. The cooling material is supplied from a forward side of a traveling direction of the irradiation region, toward the molten pool located rearward of the irradiation region in the traveling direction.

### CROSS-REFERENCE TO RELATED APPLICATIONS

This application claims the benefit of Japanese Patent Application No. 2024-134453 filed on Aug. 9, 2024 with the Japan Patent Office, and the entire disclosure of Japanese Patent Application No. 2024-134453 is incorporated herein by reference.

### BACKGROUND

The present disclosure relates to a manufacturing method and a manufacturing apparatus of a welded member.

In Japanese Unexamined Patent Application Publication No. 2003-290950, a laser welding method of joining two steel plates to each other by laser welding is disclosed. The method includes blowing a cooling gas onto a temperature-raised region (i.e., a molten pool) including the vicinity of a laser irradiation point in the steel plates being irradiated with a laser beam during welding, thereby cooling the temperature-raised region.

### SUMMARY

In the laser welding method described in Japanese Unexamined Patent Application Publication No. 2003-290950, one or more cooling gas generators for generating the cooling gas are arranged on one or both surface sides of each of the steel plates, and the cooling gas is blown onto the temperature-raised region. This can cause a problem in that the vicinity of the laser irradiation point is covered with the cooling gas generator(s) to make it difficult to blow off fumes that are fine particles generated by the laser welding.

In addition, when the cooling gas blown from the cooling gas generator(s) impinges on the welded members that are the steel plates, the cooling gas flows to surrounds of the laser irradiation point, so that the fumes, together with the cooling gas, may also flow to the surrounds of the laser irradiation point and adhere to a surrounding welding jig and the like.

An object of an aspect of the present disclosure is to enable not only cooling of a molten pool but also blowing off of fumes generated due to laser welding by supplying a cooling material such as a cooling gas when joining two metal members to each other by the laser welding.

An aspect of the present disclosure is a manufacturing method of a welded member for joining two metal members by laser welding to form the welded member.

According to the present disclosure, the manufacturing method of a welded member comprises irradiating a joining portion of the two metal members with a laser beam and moving an irradiation region of the laser beam along the joining portion.

In addition, according to the present disclosure, the manufacturing method of a welded member comprises supplying a cooling material to a molten pool in the joining portion generated by irradiation of the laser beam, thereby cooling the molten pool.

The cooling material is supplied from a forward side of a traveling direction of the irradiation region of the laser beam moving along the joining portion, toward the molten pool located rearward of the irradiation region in the traveling direction.

Accordingly, the cooling material supplied toward the molten pool is less likely to flow to the forward side of the traveling direction of the irradiation region of the laser beam, thereby making it possible to effectively cool the molten pool. In addition, since the cooling material is supplied from the forward side of the traveling direction of the irradiation region, fumes generated due to the irradiation of the laser beam can be inhibited from flowing to the forward side of the traveling direction of the irradiation region or to lateral sides relative to the traveling direction.

Therefore, it is possible to inhibit the fumes from impinging on a welding jig and the like arranged around the welded member during welding and adhering thereto.

The manufacturing method of a welded member according to the present disclosure may comprise ejecting a gas from the forward side of the traveling direction, toward the irradiation region in the joining portion to be irradiated with the laser beam.

As described above, the gas is ejected toward the irradiation region of the laser beam from the forward side of the traveling direction, thus making it possible to blow off the fumes generated due to the irradiation of the laser beam. Therefore, it is possible to inhibit processing quality and performance of the laser welding from decreasing due to the fumes.

In addition, since the gas is ejected from the forward side of the traveling direction of the irradiation region of the laser beam, the cooling material supplied toward the molten pool does not block a flow of the gas. Accordingly, although the cooling material facilitates the foregoing effects of the gas, it does not result in inhibiting the effects, and thus the cooling of the molten pool and the removal of the fumes can be achieved more effectively.

An outer wall surface of the welded member to be irradiated with the laser beam may be horizontal, and in this case, the cooling material may be supplied at an angle of 45 degrees or more relative to the outer wall surface in a side view of the outer wall surface. Also, the gas may be blown at an angle of 45 degrees or less relative to the outer wall surface in the side view.

When the cooling material is supplied in this manner, a flow of the cooling material in a plate thickness direction of the welded member is stronger than that in a horizontal direction along the outer wall surface of the welded member. Thus, it becomes possible to impinge the cooling material on the molten pool more strongly, and a cooling effect on the molten pool can be increased by the cooling material.

In addition, when the gas is blown as described above, the gas can flow more easily in the horizontal direction along the outer wall surface of the welded member than in the plate thickness direction of the welded member. Thus, the fumes generated due to the irradiation of the laser beam can be effectively removed by the gas.

When the outer wall surface of the welded member to be irradiated with the laser beam is viewed from an upper side opposing the outer wall surface, a supply angle of the cooling material and an ejection angle of the gas may be each set to be in a range of 45 degrees or less relative to a central axis along a moving direction of the irradiation region.

With this configuration, the fumes blown off by the cooling material and the gas can be inhibited from impinging on the welding jig and the like arranged around the welded member, and thus can be inhibited from adhering thereto.

In addition, when the outer wall surface of the welded member to be irradiated with the laser beam is viewed from above, the irradiation region in the joining portion to be irradiated with the laser beam may be set to be located within an ejection region of the gas.

With this configuration, the fumes generated due to the irradiation of the laser beam can be effectively removed by the gas, and thus degradation of processing quality and performance of the laser welding can be inhibited more effectively.

Another aspect of the present disclosure is a manufacturing apparatus of a welded member configured to join two metal members by laser welding to form the welded member. The manufacturing apparatus comprises an irradiator and a cooler to implement the aforementioned manufacturing method.

The irradiator is configured to irradiate a joining portion of the two metal members with a laser beam and move an irradiation region of the laser beam along the joining portion. The cooler is configured to supply a cooling material to a molten pool in the joining portion generated by the irradiation of the laser beam, thereby cooling the molten pool.

Specifically, the cooler is configured to supply the cooling material from a forward side of a traveling direction of the irradiation region of the laser beam, toward the molten pool located rearward of the irradiation region in the traveling direction. Therefore, the manufacturing apparatus of a welded member according to the present disclosure can form a welded member by the aforementioned manufacturing method, and thus similar effects to those of the aforementioned manufacturing method can be obtained.

### BRIEF DESCRIPTION OF THE DRAWINGS

An example embodiment of the present disclosure will be described hereinafter with reference to the accompanying drawings, in which:

FIG. 1 is a schematic diagram illustrating a schematic configuration of a manufacturing apparatus; and

FIG. 2 is a schematic diagram illustrating a state of a welded member as viewed from above an irradiation region of a laser beam.

### DETAILED DESCRIPTION OF EXEMPLARY EMBODIMENTS

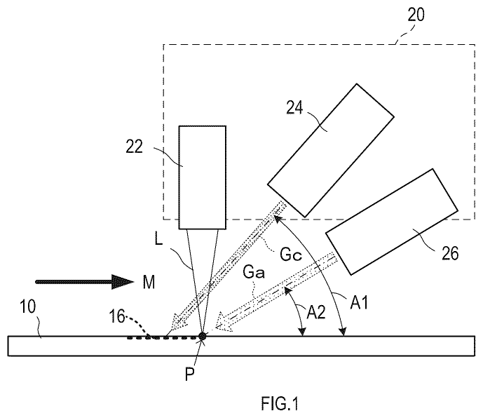

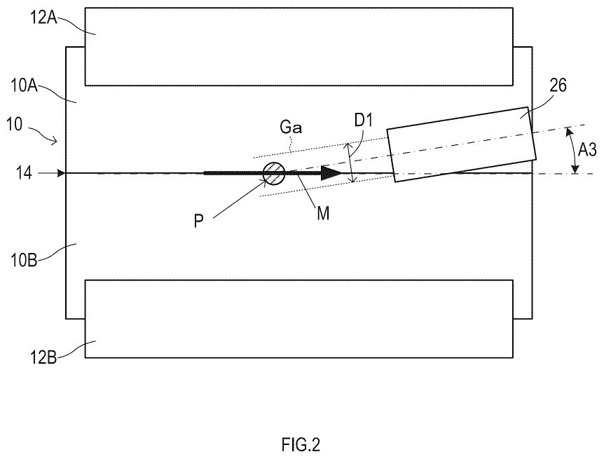

As shown in FIG. 1 and FIG. 2, a manufacturing apparatus 20 according to the present embodiment forms a welded member 10 by joining a first metal plate 10A and a second metal plate 10B, which are two metal members, by laser welding.

Each of the first metal plate 10A and the second metal plate 10B is made of metal and has a plate-like shape. Each of the first metal plate 10A and the second metal plate 10B is, for example, a steel plate. Examples of the steel plate include a galvanized steel plate.

In FIG. 2, each of the first metal plate 10A and the second metal plate 10B is formed in a rectangular shape when externally viewed, but each shape is appropriately set according to a product shape of the welded member 10. The material and thickness of the first metal plate 10A may each be the same as or different from those of the second metal plate 10B.

As shown in FIG. 2, the first metal plate 10A and the second metal plate 10B are respectively positioned and fixed via clamps 12A, 12B. The clamps 12A, 12B respectively position the metal plates 10A, 10B in a state in which end edges of the metal plates 10A, 10B, which form a joining portion 14, are butted against each other.

Next, the manufacturing apparatus 20 irradiates the joining portion 14 with laser beam L and relatively moves its irradiation region (hereinafter, referred to as “laser irradiation point”) P along the joining portion 14 in a single direction (hereinafter, referred to as “welding direction”), which is indicated by an arrow M in the drawings. Therefore, for the welded member 10, the joining portion 14 is welded by butt-welding, which is well-known.

During this welding, the laser irradiation point P is moved along the joining portion 14, and this movement may be linear movement along the joining portion 14, or may include two-dimensional movement in a transverse direction relative to the welding direction M. In other words, to weld the joining portion 14, weaving welding or wobbling welding may be used, in which the irradiation region of the laser beam L is moved in an oscillating manner in the transverse direction relative to the welding direction M.

The thus-formed welded member 10 may be subjected to additional processing, such as press molding, for example. In a case in which the first metal plate 10A and the second metal plate 10B have different plate thicknesses or/and are made of different materials, the welded member 10 is also referred to as a tailored blank.

As shown in FIG. 1, the manufacturing apparatus 20 comprises a processing head 22, a cooling nozzle 24, and an assist gas nozzle 26.

The processing head 22 emits a laser light generated by a laser oscillator as the laser beam L for laser welding through a lens and the like. The processing head 22 is arranged in a position facing the joining portion 14 of the welded member 10 such that a central axis of the laser beam L is orthogonal to a plate surface of the welded member 10.

The processing head 22, together with the cooling nozzle 24 and the assist gas nozzle 26, is relatively moved in the welding direction M by an actuator (not shown) provided in the manufacturing apparatus 20. This causes the laser irradiation point P to move along the joining portion 14 of the welded member 10, and the metal plates 10A, 10B are melted and joined to each other at the joining portion 14. The processing head 22 corresponds to an irradiator of the present disclosure.

The cooling nozzle 24 is provided to cool a molten pool 16 of the welded member 10, which is molten by irradiation of the laser beam L.

The laser irradiation point P moves along the joining portion 14 of the welded member 10 in the welding direction M. Accordingly, as viewed from the manufacturing apparatus 20, the molten pool 16 moves from the laser irradiation point P to a side opposite to the welding direction M, in other words, to a rearward side of a traveling direction of the laser irradiation point P.

Accordingly, the cooling nozzle 24 is arranged such that a cooling gas Gc pas a cooling material is blown from a front side toward a rear side of the traveling direction of the laser irradiation point P. Therefore, the cooling gas Gc blown from the cooling nozzle 24 can effectively cool the molten pool 16 extending rearward of the laser irradiation point P in the traveling direction.

As the cooling gas Gc, for example, air is used, but a gas including a liquid for cooling may be used. The cooling material may be a liquid or may be in mist form. The cooling nozzle 24 corresponds to a cooler of the present disclosure.

The assist gas nozzle 26 ejects an assist gas Ga toward the laser irradiation point P. The assist gas Ga is used to blow off the fumes generated due to the laser welding. As the assist gas Ga, for example, air is used, but for the gas of the present disclosure, an inert gas (i.e., a shielding gas) such as argon or helium may also be used. In a case in which a shielding gas is used as the assist gas Ga, a shielding gas nozzle may be used instead of the assist gas nozzle 26.

The assist gas nozzle 26 is arranged to eject the assist gas Ga toward the laser irradiation point P from a forward side of the traveling direction of the laser irradiation point P. Since the ejecting direction is the same as the blowing direction of the cooling gas Gc from the cooling nozzle 24, a flow of the assist gas Ga is not blocked by the cooling gas Gc.

Accordingly, the fumes are blown off to the rearward side of the traveling direction of the laser irradiation point P by the assist gas Ga and the cooling gas Gc, and thus degradation of processing quality and performance of the laser welding due to the fumes can be inhibited more effectively. Also, the fumes can be inhibited from adhering to welding jigs such as the clamps 12A, 12B.

A central axis angle A1 of blowing (hereinafter, referred to as “blowing angle A1”) of the cooling gas Gc blown from the cooling nozzle 24, and a central axis angle A2 of ejection (hereinafter, referred to as “ejection angle A2”) of the assist gas Ga ejected from the assist gas nozzle 26 as shown in FIG. 1 are each set as described below. The blowing angle A1 of the cooling gas Gc corresponds to a supply angle of the cooling material of the present disclosure.

Specifically, both the cooling nozzle 24 and the assist gas nozzle 26 are positioned on a side of an outer wall surface of the welded member 10 to be irradiated with the laser beam L, or a surface of the welded member 10 located on a processing head 22 side. When the outer wall surface of the welded member 10 is horizontal and at 0 degree, the cooling nozzle 24 is arranged such that the blowing angle A1 of the cooling gas Gc relative to the outer wall surface of the welded member 10 is 45 degrees or more, in a side view of the outer wall surface of the welded member 10. Similarly, the assist gas nozzle 26 is arranged such that the ejection angle A2 of the assist gas Ga relative to the outer wall surface of the welded member 10 is 45 degrees or less, in the side view.

As a result, a flow of the cooling gas Gc blown from the cooling nozzle 24 in a plate thickness direction of the welded member 10 is stronger than that in the horizontal direction along the outer wall surface of the welded member 10. Thus, it is possible to impinge the cooling gas Gc on the molten pool 16 more strongly to increase a cooling effect of the cooling gas Gc on the molten pool 16.

In contrast, the assist gas Ga ejected from the assist gas nozzle 26 is more likely to flow in the horizontal direction along the outer wall surface of the welded member 10 than in the plate thickness direction of the welded member 10. This enables the assist gas Ga to effectively blow off the fumes, which are generated due to the irradiation of the laser beam L, to the rearward side of the traveling direction of the laser irradiation point P.

In addition, as shown in FIG. 2, the assist gas nozzle 26 is arranged such that an ejection angle A3 in a top view from above the outer wall surface of the welded member 10 is in an angular range of 45 degrees or less on each of both of the left side and the right side relative to the central axis (0 degree) along the welding direction M coinciding with the moving direction of the laser irradiation point P.

Although not shown in FIG. 2, similarly to the description above, the cooling nozzle 24 is arranged such that the blowing angle of the cooling nozzle 24 in a top view is within an angular range of 45 degrees or less on each of the left side and the right side relative to the central axis along the welding direction M (in other words, relative to an axis along the joining portion 14).

As a result, adhesion of the fumes flowing to lateral sides of the welded member 10 spaced apart from the joining portion 14, to the welding jigs such as the clamps 12A, 12B adjacent to the lateral sides of the welded member 10 can be more effectively inhibited by the assist gas Ga or the cooling gas Gc.

The processing head 22 is set such that a size of the irradiation region of the laser beam L on the outer wall surface of the welded member 10, in other words, a size of the laser irradiation point P, is to be within an ejection region of the assist gas Ga. In other words, the irradiation region of the laser beam L with which the welded member 10 is irradiated is smaller than a diameter D1 of an ejection port of the assist gas nozzle 26 for ejecting the assist gas Ga.

Therefore, the fumes generated due to the irradiation of the laser beam L can be effectively removed by the assist gas Ga to increase the processing quality and performance of the laser welding.

To cool the molten pool 16 more quickly, the cooling gas Gc to be blown from the cooling nozzle 24 may be set to a lower temperature than that of the assist gas Ga to be ejected from the assist gas nozzle 26.

However, since the temperatures of the laser irradiation point P and the molten pool 16 are significantly higher than a room temperature, even if the temperature of the cooling gas Gc is the same as that of the assist gas Ga, the molten pool 16 can be cooled.

For flow velocities of the cooling gas Gc and the assist gas Ga, the flow velocity of the cooling gas Gc may be higher, compared with that of the assist gas Ga. In other words, as the flow velocity of the cooling gas Gc increases, the cooling gas Gc can reach the molten pool 16 on the outer wall surface of the welded member 10 more easily to increase the cooling effect.

In order to do that, in a case in which the assist gas Ga and the cooling gas Gc have the same gas pressure, a nozzle diameter of the cooling nozzle 24 may be smaller than a nozzle diameter of the assist gas nozzle 26.

In a case in which the cooling nozzle 24 and the assist gas nozzle 26 have the same nozzle diameter, the gas pressure may be adjusted so that the gas pressure of the cooling gas Gc is higher than that of the assist gas Ga.

### OTHER EMBODIMENTS

Although the embodiment of the present disclosure has been described, the present disclosure is not limited to the above-described embodiment and may be embodied in various forms.

In the manufacturing apparatus 20 of the embodiment described above, the irradiation of the laser beam L is applied by the processing head 22, the cooling gas Gc as a cooling material is blown by the cooling nozzle 24, and the assist gas Ga is ejected by the assist gas nozzle 26.

However, ejection of the assist gas Ga from the assist gas nozzle 26 does not necessarily have to be performed. When the laser welding with the laser beam L is being performed on the welded member 10, simply blowing the cooling gas Gc from the cooling nozzle 24 to the molten pool 16 is sufficient.

In other words, the cooling nozzle 24 blows the cooling gas Gc from the forward side of the traveling direction of the laser irradiation point P toward the molten pool 16 located rearward in the traveling direction, so that the fumes generated due to the laser welding are blown off to the rearward side of the traveling direction of the laser irradiation point by the cooling gas Gc. Therefore, when the laser welding is being performed, simply blowing the cooling gas Gc from the cooling nozzle 24 toward the molten pool 16 can achieve a primary purpose of the present disclosure.

The central axis of the blowing of the cooling gas Gc from the cooling nozzle 24 does not have to pass through the laser irradiation point P as viewed from above, and may be provided such that the cooling gas Gc is blown from a location ahead of the laser irradiation point P in the traveling direction toward the molten pool 16.

In the embodiment, the nozzle diameters of the cooling nozzle 24 and the assist gas nozzle 26 have been described. The ejection port of each of the cooling nozzle 24 and the assist gas nozzle 26 does not necessarily have to be circular, and may be appropriately changed. In addition, the cooling nozzle 24 and the assist gas nozzle 26 may be different from each other in the shape of the ejection port or the entire nozzle.

In FIG. 1, a position of a leading end of the cooling nozzle 24 is closer to the laser irradiation point P than that of the assist gas nozzle 26 in an axial direction along the welding direction M. However, locations of leading ends of the cooling nozzle 24 and the assist gas nozzle 26 may be the same or may be switched in front-rear directions along the welding direction M.

In the above-described embodiment, the processing head 22, the cooling nozzle 24, and the assist gas nozzle 26 have been described, which are each moved in the welding direction M along a welded portion of the welded member 10 by the actuator provided in the manufacturing apparatus 20.

For this actuator, for example, a robot may be utilized, which has a robotic arm to which a welding device including the processing head 22, the cooling nozzle 24, and the assist gas nozzle 26 is attached, so that the robotic arm can move each of these components.

Alternatively, the manufacturing apparatus 20 including the processing head 22, the cooling nozzle 24, and the assist gas nozzle 26 may be fixed and the welded member 10 positioned by the clamps 12A, 12B may be moved relative to the processing head 22.

A function of a single component of the aforementioned embodiments may be distributed to a plurality of components, and functions of a plurality of components may be achieved by a single component. A part of the configurations of the aforementioned embodiments may be omitted. At least a part of the configurations of the aforementioned embodiments may be added to or replaced with the configuration of another embodiment.

### Technical Idea Disclosed by the Present Specification

### [Item 1]

A manufacturing method of a welded member for joining two metal members by laser welding to form the welded member, the manufacturing method comprising:
irradiating a joining portion of the two metal members with a laser beam and moving an irradiation region of the laser beam along the joining portion; and
supplying a cooling material to a molten pool in the joining portion generated by irradiation of the laser beam, thereby cooling the molten pool,
the cooling material being supplied from a forward side of a traveling direction of the irradiation region of the laser beam moving along the joining portion, toward the molten pool located rearward of the irradiation region in the traveling direction.

### [Item 2]

The manufacturing method of a welded member according to Item 1, further comprising ejecting a gas from the forward side of the traveling direction of the irradiation region, toward the irradiation region in the joining portion to be irradiated with the laser beam.

### [Item 3]

The manufacturing method of a welded member according to Item 2, wherein an outer wall surface of the welded member to be irradiated with the laser beam is horizontal,
the cooling material is supplied at an angle of 45 degrees or more relative to the outer wall surface, in a side view of the outer wall surface, and
the gas is blown at an angle of 45 degrees or less relative to the outer wall surface in the side view.

### [Item 4]

The manufacturing method of a welded member according to Item 2 or 3, wherein
when an outer wall surface of the welded member to be irradiated with the laser beam is viewed from an upper side opposing the outer wall surface, a supply angle of the cooling material and an ejection angle of the gas are each set to be in a range of 45 degrees or less relative to a central axis along a moving direction of the irradiation region.

### [Item 5]

The manufacturing method of a welded member according to any one of Items 2 to 4, wherein
when an outer wall surface of the welded member to be irradiated with the laser beam is viewed from an upper side opposing the outer wall surface, the irradiation region in the joining portion to be irradiated with the laser beam is set to be located within an ejection region of the gas.

### [Item 6]

A manufacturing apparatus of a welded member, the manufacturing apparatus being configured to join two metal members by laser welding to form the welded member, the manufacturing apparatus comprising:
an irradiator configured to irradiate a joining portion of the two metal members with a laser beam and move an irradiation region of the laser beam along the joining portion; and
a cooler configured to supply a cooling material to a molten pool in the joining portion generated by irradiation of the laser beam, thereby cooling the molten pool,
the cooler being configured to supply the cooling material from a forward side of a traveling direction of the irradiation region moving along the joining portion, toward the molten pool located rearward of the irradiation region in the traveling direction.

What is claimed is:

1. A manufacturing method of a welded member for joining two metal members by laser welding to form the welded member, the manufacturing method comprising:
irradiating a joining portion of the two metal members with a laser beam and moving an irradiation region of the laser beam along the joining portion; and
supplying a cooling material to a molten pool in the joining portion generated by irradiation of the laser beam, thereby cooling the molten pool,
the cooling material being supplied from a forward side of a traveling direction of the irradiation region of the laser beam moving along the joining portion, toward the molten pool located rearward of the irradiation region in the traveling direction.

2. The manufacturing method of a welded member according to claim 1, further comprising ejecting a gas from the forward side of the traveling direction of the irradiation region, toward the irradiation region in the joining portion to be irradiated with the laser beam.

3. The manufacturing method of a welded member according to claim 2, wherein
an outer wall surface of the welded member to be irradiated with the laser beam is horizontal,
the cooling material is supplied at an angle of 45 degrees or more relative to the outer wall surface in a side view of the outer wall surface, and
the gas is blown at an angle of 45 degrees or less relative to the outer wall surface in the side view.

4. The manufacturing method of a welded member according to claim 2, wherein
when an outer wall surface of the welded member to be irradiated with the laser beam is viewed from an upper side opposing the outer wall surface, a supply angle of the cooling material and an ejection angle of the gas are each set to be in a range of 45 degrees or less relative to a central axis along a moving direction of the irradiation region.

5. The manufacturing method of a welded member according to claim 2, wherein
when an outer wall surface of the welded member to be irradiated with the laser beam is viewed from an upper side opposing the outer wall surface, the irradiation region in the joining portion to be irradiated with the laser beam is set to be located within an ejection region of the gas.

6. The manufacturing method of a welded member according to claim 3, wherein
when an outer wall surface of the welded member to be irradiated with the laser beam is viewed from an upper side opposing the outer wall surface, the irradiation region in the joining portion to be irradiated with the laser beam is set to be located within an ejection region of the gas.

7. The manufacturing method of a welded member according to claim 4, wherein
when an outer wall surface of the welded member to be irradiated with the laser beam is viewed from an upper side opposing the outer wall surface, the irradiation region in the joining portion to be irradiated with the laser beam is set to be located within an ejection region of the gas.

8. A manufacturing apparatus of a welded member, the manufacturing apparatus being configured to join two metal members by laser welding to form the welded member, the manufacturing apparatus comprising:
an irradiator configured to irradiate a joining portion of the two metal members with a laser beam and move an irradiation region of the laser beam along the joining portion; and
a cooler configured to supply a cooling material to a molten pool generated in the joining portion by irradiation of the laser beam, thereby cooling the molten pool,
the cooler being configured to supply the cooling material from a forward side of a traveling direction of the irradiation region moving along the joining portion, toward the molten pool located rearward of the irradiation region in the traveling direction.
